(19) United States
(12) Patent Application Publication
(10) Pub. No.: US 2019/0054897 A1
(43) Pub. Date: Feb. 21, 2019

(54) VEHICLE COMMUNICATION SYSTEM, ON-BOARD DEVICE, AND PORTABLE DEVICE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Kazutaka NAITOU, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/069,565

(22) PCT Filed: Jan. 16, 2017
(86) PCT No.: PCT/JP2017/001240

§ 371 Date: Jul. 12, 2018

(30) Foreign Application Priority Data
Jan. 27, 2016 (JP) 2016-013702

(51) Int. Cl. B60R 25/24

(52) U.S. Cl. CPC B60R 25/24

(57) ABSTRACT

A vehicle communication system includes an on-board device that transmits a position detection signal; and a portable device that receives the position detection signal and transmits a response signal. The portable device detects a walk state of a user holding the portable device; and transmits a walk state signal that indicates the walk state. The on-board device receives the response signal and the walk state signal transmitted from the portable device, and determines whether or not a vehicle door needs to be locked, based on the signals thus received. Upon determining that the vehicle door needs to be locked, the on-board device outputs a lock signal.

### TECHNICAL FIELD

The present disclosure relates to a vehicle communication system, an on-board device, and a portable device.

The present application claims priority to JP 2016-13702A filed Jan. 27, 2016, the entire contents of which are incorporated herein by reference.

### BACKGROUND ART

Vehicle communication systems that lock and unlock a vehicle door without using a mechanical key have come into practical use. Specifically, a SMART ENTRY (registered trademark) system, which allows a user holding a portable device to unlock a vehicle door by simply approaching the vehicle or holding a door handle, has come into practical use, for example.

In addition, a vehicle communication system that starts the engine of a vehicle without using a mechanical key has come into practice. Specifically, a SMART START (registered trademark) system, which allows a user who has a portable device, to start the engine upon the user simply pressing an engine start button, has come into practice.

Furthermore, there is a Walk Away Closing (WAC) system that automatically locks a vehicle door when there are no response signals from a portable device responding to position detection signals that are periodically transmitted from an on-board device. In addition, there is a WAC system in which a portable device measures the received signal strength of position detection signals in an LF band, transmitted from an on-board device, and that automatically locks a vehicle door when the received signal strength decreases, determining that the user has moved away from the vehicle.

### CITATION LIST

### Patent Documents

Patent Document 1: JP2012-102529A

Patent Document 2: JP2011-25715A

Patent Document 3: JP2011-25713A

### SUMMARY

A vehicle communication system according to one aspect of the present disclosure is a vehicle communication system including: an on-board device that transmits a position detection signal; and a portable device that receives the position detection signal and transmits a response signal, the on-board device outputting a lock signal that provides an instruction to lock a vehicle door depending on a reception state of the response signal transmitted from the portable device. The portable device includes: a walk detection unit that detects a walk state of a user holding the portable device; and a transmission unit that transmits a walk state signal that indicates the walk state of the user detected by the walk detection unit, and the on-board device includes: a reception unit that receives the response signal and the walk state signal transmitted from the portable device; a determination unit that determines whether or not the vehicle door needs to be locked, based on the walk state of the user indicated by the walk state signal and the reception state of the response signal; and an output unit that outputs the lock signal upon the determination unit determining that the vehicle door needs to be locked.

An on-board device according to one aspect of invention preferred embodiment is an on-board device that transmits a position detection signal, and provides an instruction to lock a vehicle door depending on a reception state of a response signal transmitted from a portable device that has received the position detection signal, the on-board device including: a reception unit that receives the response signal and a walk state signal transmitted from the portable device, the walk state signal indicating a walk state of a user holding the portable device; a determination unit that determines whether or not the vehicle door needs to be locked, based on the walk state of the user indicated by the walk state signal, and the reception state of the response signal; and an output unit that outputs a lock signal upon the determination unit determining that the vehicle door needs to be locked, the lock signal providing an instruction to lock the vehicle door.

A portable device according to one aspect of invention preferred embodiment is a portable device that receives a position detection signal transmitted from an on-board device, and transmits a response signal, the portable device including: a walk detection unit that detects a walk state of a user holding the portable device; and a transmission unit that transmits a walk state signal that indicates the walk state of the user detected by the walk detection unit.

Note that the present application can be realized not only as a vehicle communication system, an on-board device, and a portable device that are each provided with such characteristic processing units, but also as a vehicle communication method that includes such characteristic processing as steps, and a program for causing a computer to execute such steps, for example. Also, the present application can be realized as a semiconductor integrated circuit that realizes part or all of the vehicle communication system, the on-board device, and the portable device, or another system that includes the vehicle communication system, the on-board device, and the portable device, for example.

### BRIEF DESCRIPTION OF DRAWINGS

FIG. 1 is a block diagram showing an example of a configuration of a vehicle communication system according to a first embodiment.

FIG. 2 is a block diagram showing an example of a configuration of an on-board device according to the first embodiment.

FIG. 3 is a block diagram showing an example of a configuration of a portable device according to the first embodiment.

FIG. 4 is a flowchart showing processing procedures for locking according to the first embodiment.

FIG. 5 is a conceptual diagram showing a communication range of position detection signals, and a response signal and a walk state signal.

FIG. 6 is a conceptual diagram showing the communication range of position detection signals, and a walk state signal, in a situation where a user moves away from a vehicle.

FIG. 7 is a block diagram showing an example of a configuration of a portable device according to a second embodiment.

FIG. 8 is a flowchart showing processing procedures for locking according to the second embodiment.

### DESCRIPTION OF EMBODIMENTS

### Problem to be Solved by Present Disclosure

A portable device can receive position detection signals in the LF band within a radius of approximately 2 m to 3 m around an antenna that transmits position detection signals, and it is impossible to accurately detect that a user holding the portable device has moved away from the vehicle, which is a problem.

For example, if antennas that transmit position detection signals are provided near a driver's seat-side vehicle door, near a passenger's seat-side vehicle door, and near a backdoor, there are cases where the portable device fails to receive position detection signals while the user moves from the driver's seat to a position near a backdoor, and the vehicle doors are locked. Also, there are cases where the portable device fails to receive position detection signals when the user moves away to a position that is rearward of the vehicle to open a backdoor, and the vehicle doors are locked.

The present application aims to provide a vehicle communication system, an on-board device, and a portable device with which it is possible to detect, without error, a situation where a portable device is moved away from a vehicle, and to lock a vehicle door.

### Advantageous Effects of Present Disclosure

The present disclosure can provide a vehicle communication system, an on-board device, and a portable device with which it is possible to detect, without error, a situation where a portable device is moved away from a vehicle, and to lock a vehicle door.

### DESCRIPTIONS OF PREFERRED EMBODIMENTS

First, the following lists up and describes preferred embodiments. At least some of the following embodiments may be combined with each other as appropriate.

(1) A vehicle communication system according to one preferred embodiment is a vehicle communication system including: an on-board device that transmits a position detection signal; and a portable device that receives the position detection signal and transmits a response signal, the on-board device outputting a lock signal that provides an instruction to lock a vehicle door depending on a reception state of the response signal transmitted from the portable device. The portable device includes: a walk detection unit that detects a walk state of a user holding the portable device; and a transmission unit that transmits a walk state signal that indicates the walk state of the user detected by the walk detection unit, and the on-board device includes: a reception unit that receives the response signal and the walk state signal transmitted from the portable device; a determination unit that determines whether or not the vehicle door needs to be locked, based on the walk state of the user indicated by the walk state signal and the reception state of the response signal; and an output unit that outputs the lock signal upon the determination unit determining that the vehicle door needs to be locked.

According to this aspect, upon receiving the position detection signal transmitted from the on-board device, the portable device transmits a response signal. Also, the portable device transmits a walk state signal that indicates the walk state of the user holding the portable device.

The on-board device receives the response signal and the walk state signal transmitted from the portable device. The on-board device can determine whether or not the user has moved away from the vehicle and the vehicle door needs to be locked, based on the walk state of the user indicated by the walk state signal, in addition to the reception state of the response signal. Upon the determination unit determining that the vehicle door needs to be locked, the output unit outputs a lock signal to lock the vehicle door.

As described above, according to the present aspect, it is possible to detect a situation where the user moves away from the vehicle, based on the walk state of the user in addition to the reception state of the position detection signal received by the portable device. Therefore, it is possible to more accurately detect a situation where the portable device held by the user is moved away from the vehicle, and lock the vehicle door.

(2) It is preferable that the walk detection unit includes a vibration sensor that detects vibrations generated as a result of the user walking, and the determination unit determines that the vehicle door needs to be locked if the vibration sensor has detected continuous vibrations generated as a result of the user walking, and the response signal transmitted from the portable device that has received the position detection signal has not been received.

According to this aspect, the on-board device can detect a situation where the user moves away from the vehicle, based on the reception state of the response signal and continuous vibrations generated as a result of the user walking.

Therefore, even when the user has moved to a specific position near the vehicle, at which the portable device cannot receive a position detection signal, if the user is stationary, the on-board device does not erroneously detect a situation where the user has moved away from the vehicle, and there is no possibility of the vehicle door being erroneously locked.

(3) It is preferable that the walk detection unit includes a multi-axis acceleration sensor that detects vibrations and a linear acceleration generated as a result of the user walking, and the determination unit determines that the vehicle door needs to be locked if the vibration sensor has detected continuous vibrations generated as a result of the user walking, and the response signal transmitted from the portable device that has received the position detection signal has not been received.

According to this aspect, the on-board device can detect a situation where the user moves away from the vehicle, based on the reception state of the response signal, and continuous vibrations and a linear acceleration generated as a result of the user walking.

Therefore, even when the user has moved to a specific position near the vehicle, at which the portable device cannot receive a position detection signal, if the user is non-linearly walking, e.g. the user is moving around the vehicle, the on-board device does not erroneously detect a situation where the user has moved away from the vehicle, and there is no possibility of the vehicle door being erroneously locked.

(4) It is preferable that the portable device intermittently transmits the walk state signal even after the position detection signal is no longer received, and the output unit outputs the lock signal if the determination unit determines, a plurality of times, that the vehicle door needs to be locked, based on the walk state signal intermittently transmitted from the portable device.

According to this aspect, the on-board device continuously monitors the reception state of the response signal and the walk state of the user, and outputs the lock signal to lock the vehicle door if it is determined, a plurality of times, that the vehicle door needs to be locked.

Therefore, it is possible to more accurately detect a situation where the portable device held by the user is moved away from the vehicle, and lock the vehicle door.

(5). An on-board device according to one preferred embodiment is an on-board device that transmits a position detection signal, and provides an instruction to lock a vehicle door depending on a reception state of a response signal transmitted from a portable device that has received the position detection signal, the on-board device including: a reception unit that receives the response signal and a walk state signal transmitted from the portable device, the walk state signal indicating a walk state of a user holding the portable device; a determination unit that determines whether or not the vehicle door needs to be locked, based on the walk state of the user indicated by the walk state signal, and the reception state of the response signal; and an output unit that outputs a lock signal upon the determination unit determining that the vehicle door needs to be locked, the lock signal providing an instruction to lock the vehicle door.

The on-board device according to the present aspect can constitute a vehicle communication system with which it is possible to detect, without error, a situation where the portable device is moved away from the vehicle, and to lock the vehicle door.

(6) A portable device according to one preferred embodiment is a portable device that receives a position detection signal transmitted from an on-board device, and transmits a response signal, the portable device including: a walk detection unit that detects a walk state of a user holding the portable device; and a transmission unit that transmits a walk state signal that indicates the walk state of the user detected by the walk detection unit.

The portable device according to the present aspect can constitute a vehicle communication system with which it is possible to detect, without error, a situation where the portable device is moved away from the vehicle, and to lock the vehicle door.

### Details of Embodiments

The following describes specific examples of a vehicle communication system according to embodiments with reference to the drawings. Note that the present invention is not limited to the examples, and is specified by the scope of claims. All changes that come within the meaning and range of equivalency of the claims are intended to be embraced therein.

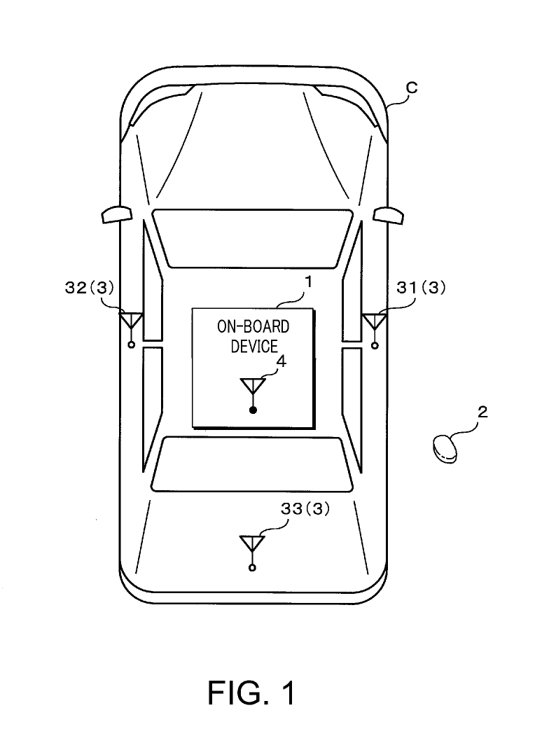

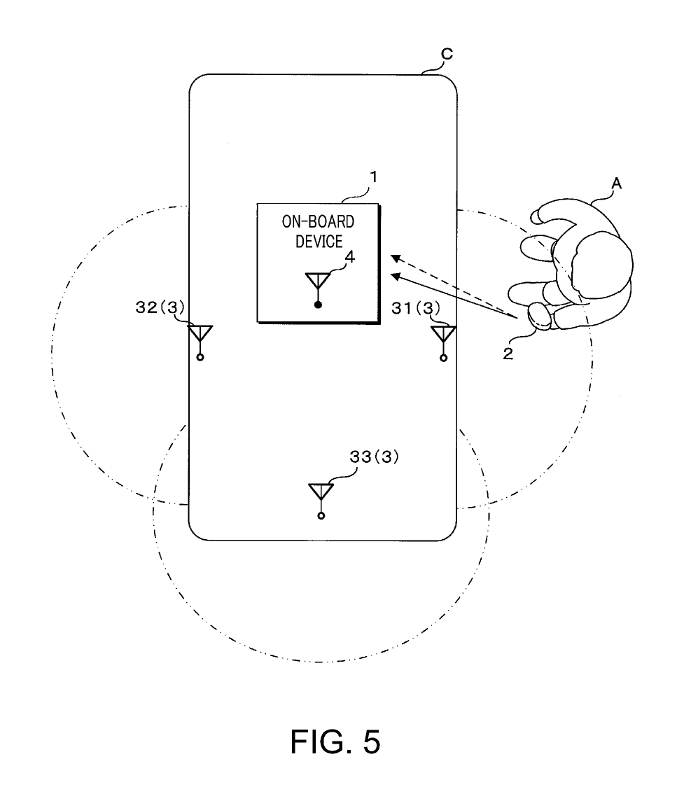

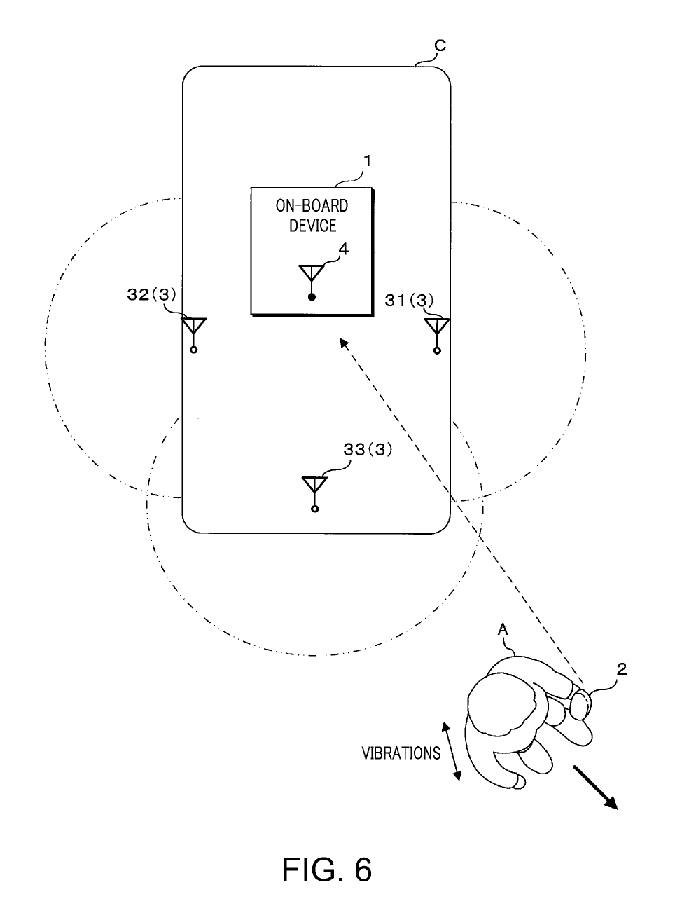

FIG. 1 is a block diagram showing an example of a configuration of a vehicle communication system according to a first embodiment. The vehicle communication system according to the first embodiment includes an on-board device 1 that transmits and receives various signals using a plurality of LF transmission antennas 3 and an RF reception antenna 4, and a portable device 2 that transmits/receives signals to/from the on-board device 1. The on-board device 1 detects a state where the portable device 2 is moved away from the vehicle C based on the position of the portable device 2 and a walk state of a user A holding the portable device 2 (see FIGS. 5 and 6), and automatically locks the vehicle doors upon detecting such a state.

The plurality of LF transmission antennas 3 include, for example, a first LF transmission antenna 31 that is located on a driver's seat-side pillar, a second LF transmission antenna 32 that is located on a passenger's seat-side pillar, a third LF transmission antenna 33 that is located on the backdoor side, and so on. Each LF transmission antenna 3 transmits signals using radio waves in the LF band.

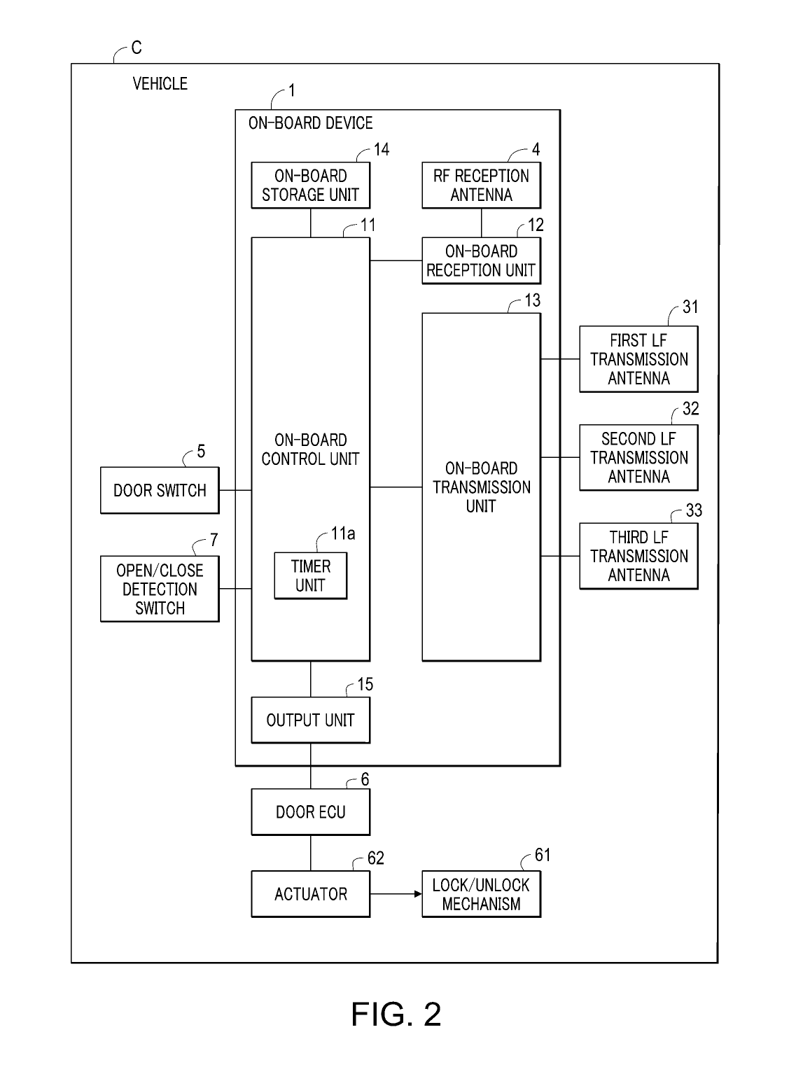

FIG. 2 is a block diagram showing an example of a configuration of the on-board device 1 according to the first embodiment. The on-board device 1 includes an on-board control unit 11 that controls operations of each constituent unit of the on-board device 1. The on-board control unit 11 is, for example, a microcomputer that includes at least one CPU (Central Processing Unit), a multicore CPU, a ROM (Read Only Memory), a RAM (Random Access Memory), a timer unit 11a, and so on. The on-board control unit 11 is provided with an on-board reception unit 12, an on-board transmission unit 13, an on-board storage unit 14, and an output unit 15.

The on-board control unit 11 executes a control program described below, which is stored in the on-board storage unit 14, to control operations of each constituent unit, specifies the position of the portable device 2, and performs control to automatically lock the vehicle doors in a situation where the portable device 2 is at a distance from the vehicle C.

The on-board storage unit 14 is a non-volatile memory such as an EEPROM (Electrically Erasable Programmable ROM) or a flash memory. The on-board storage unit 14 stores a control program that enables the on-board control unit 11 to control operations of each constituent component of the on-board device 1, to specify the position of the portable device 2, and lock the vehicle doors depending on the walk state of the user A holding the portable device 2.

The on-board reception unit 12 is connected to the RF reception antenna 4. The on-board reception unit 12 receives various signals transmitted from the portable device 2 using radio waves in a UHF band, and outputs the received signals to the on-board control unit 11. Since the range of communication using radio waves in the UHF band is wide, the position of the RF reception antenna 4 in the vehicle C is not specifically limited.

The on-board transmission unit 13 is connected to the plurality of LF transmission antennas 3, and transmits various signals to specify the position of the portable device 2, under the control of the on-board control unit 11. For example, under the control of the on-board control unit 11, the on-board transmission unit 13 transmits activation signals to activate the portable device 2, and position detection signals to detect the position of the portable device 2. Position detection signals are signals for specifying the position of the portable device 2 based on whether or not the position detection signals have been successfully received by the portable device 2. Position detection signals are carrier waves that have been modulated, for example. The strength of position detection signals transmitted from the first LF transmission antenna 31 is such that the portable device 2 can receive the position detection signals when the portable device 2 is located in the vicinity of the driver's seat-side vehicle door, such as at a distance of from 2 m to 3 m, for example. Similarly, the strength of position detection signals transmitted from the second LF transmission antenna 32 and the third LF transmission antenna 33 is such that the portable device 2 can receive the position detection signals when the portable device 2 is located in the vicinity of the passenger's seat-side vehicle door and in the vicinity of the back door-side vehicle door, such as at a distance of from 2 m to 3 m, for example.

A door ECU 6 is connected to the output unit 15, and the output unit 15 outputs a lock signal, which provides an instruction to lock the vehicle doors, to the door ECU 6, under the control of the on-board control unit 11. The vehicle C includes a lock/unlock mechanism 61, which is a well-known mechanism for locking/unlocking the vehicle doors, and an actuator 62 that actuates the lock/unlock mechanism 61. The actuator 62 is connected to the door ECU 6, and the door ECU 6 operates the actuator 62 in response to a lock signal output from the output unit 15 of the on-board device 1, to lock the vehicle doors.

A door switch 5 is connected to the on-board control unit 11, and a door signal that corresponds to the operational state of the door switch is input to the on-board control unit 11. The on-board control unit 11 can recognize the operational state of the door switch 5 based on a door signal from the door switch 5. If the door switch 5 is operated in a state where the vehicle doors are unlocked, and it is confirmed that an authorized portable device 2 is located outside the vehicle C, the on-board control unit 11 outputs a lock signal to the door ECU 6 using the output unit 15, to lock the vehicle doors. Also, if the door switch 5 is operated in a state where the vehicle doors are locked, and it is confirmed that an authorized portable device 2 is located outside the vehicle C, the on-board control unit 11 outputs an unlock signal to the door ECU 6 using the output unit 15, to unlock the vehicle doors.

An open/close detection switch 7 for detecting the open/closed state of the vehicle doors is also connected to the on-board control unit 11. The open/close detection switch 7 inputs an open/close signal, which is turned ON and OFF in response to opening and closing of the vehicle doors, to the on-board control unit 11. The on-board control unit 11 can recognize the open/closed state of the vehicle doors based on the input open/close signal.

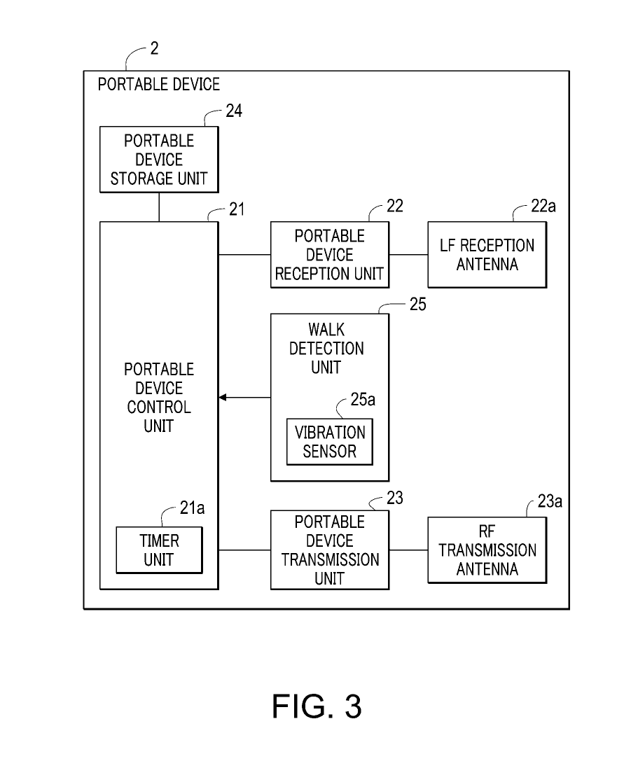

FIG. 3 is a block diagram showing an example of a configuration of the portable device 2 according to the first embodiment. The portable device 2 includes a portable device control unit 21 that controls operations of each constituent unit of the portable device 2. The portable device control unit 21 is, for example, a microcomputer that includes at least one CPU (Central Processing Unit), a multicore CPU, a ROM, a RAM, a timer unit 21a, and so on. The portable device control unit 21 is provided with a portable device reception unit 22, a portable device transmission unit 23, a portable device storage unit 24, and a walk detection unit 25.

The portable device control unit 21 reads out a control program described below, which is stored in the portable device storage unit 24, to control operations of each constituent unit, thereby performing processing to transmit information required for determining whether or not the vehicle doors need to be locked, to the on-board device 1.

The portable device storage unit 24 is a non-volatile memory that is similar to the on-board storage unit 14. The portable device storage unit 24 stores a control program that is used by the portable device control unit 21 to control each constituent unit of the portable device 2 to perform processing to transmit, for example, a response signal that includes information required for determining whether or not the vehicle doors need to be locked, to the on-board device 1.

The portable device reception unit 22 is connected to an LF reception antenna 22a. The portable device reception unit 22 receives various signals such as activation signals and position detection signals transmitted from the on-board device 1 using radio waves in the LF band, and outputs the received signals to the portable device control unit 21. The LF reception antenna 22a is a three-axis antenna, for example, and is able to achieve a received signal strength at a certain level regardless of the direction or the orientation of the portable device 2 relative to the vehicle C. The portable device reception unit 22 demodulates the position detection signals received by the LF reception antenna 22a, and outputs the signals obtained through demodulation to the portable device control unit 21.

The walk detection unit 25 includes a vibration sensor 25a that detects vibrations in a vertical direction generated as a result of, for example, the user A holding the portable device 2 walking. The vibration sensor 25a is an acceleration sensor, for example, and is a circuit that outputs a signal that indicates the detected vibrations to the portable device control unit 21.

The portable device transmission unit 23 is connected to an RF transmission antenna 23a, and transmits various signals under the control of the portable device control unit 21. For example, if the portable device transmission unit 23 successfully receives or demodulates a position detection signal transmitted from the on-board device 1, the portable device transmission unit 23 transmits a response signal. The portable device transmission unit 23 also transmits a walk state obtained through detection by the walk detection unit 25, specifically, a walk state signal that indicates the state of vibrations. Upon being activated, the portable device transmission unit 23 continuously transmits walk state signals over a predetermined period of time, even after the portable device transmission unit 23 no longer receives a position detection signal. The portable device transmission unit 23 transmits response signals using radio waves in the UHF band. Note that the UHF band is an example of a radio wave band used to transmit signals, and the radio wave band is not limited to the UHF band.

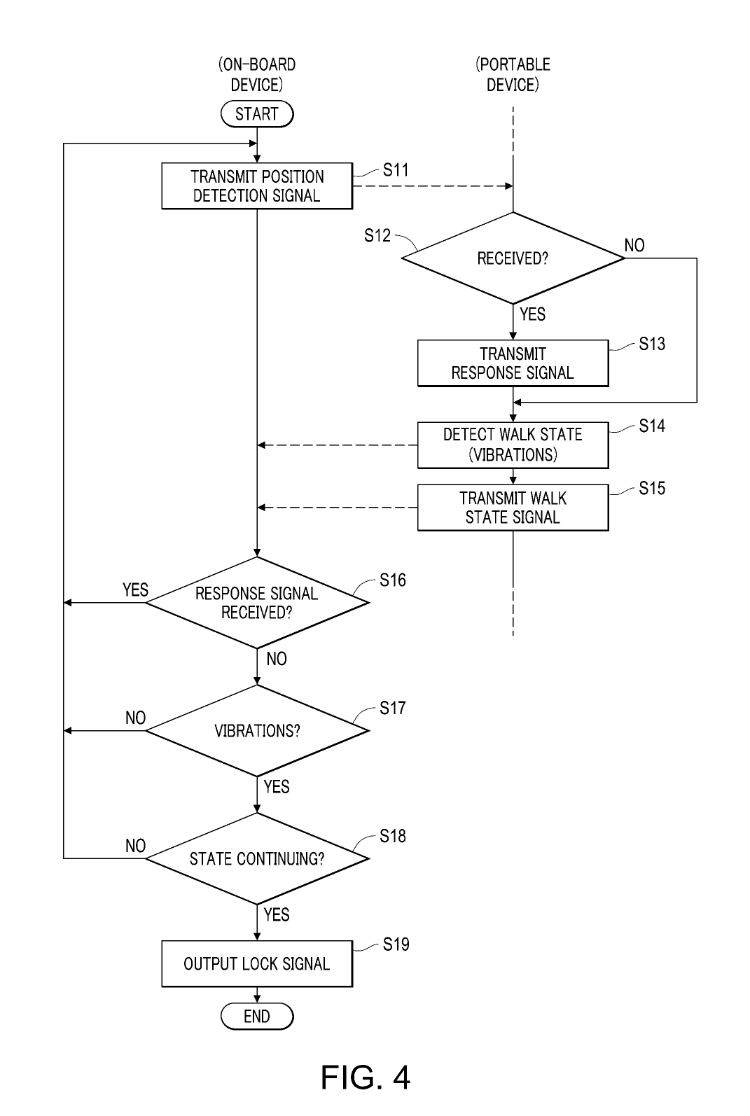

FIG. 4 is a flowchart showing processing procedures for locking according to the first embodiment. The on-board control unit 11 monitors the state of the open/close detection switch 7, and starts the following processing upon being triggered by the fact that the vehicle doors in an open state are closed, for example. The on-board control unit 11 that has detected opening/closing of the vehicle doors transmits an activation signal that activates the portable device 2, and a position detection signal, to the on-board transmission unit 13 from the LF transmission antenna 3 (step S11). Usually, the portable device 2 is in a waiting state where power consumption is low, and transitions to an active state upon receiving an activation signal transmitted from the on-board device 1. The portable device 2 thus activated is held in an active state over at least a predetermined period of time, and repeatedly performs processing in steps S12 to S15 described below. Although details are omitted, the on-board device 1 and the portable device 2 perform authentication processing upon the portable device 2 being activated.

The portable device 2 activated by the activation signal determines whether or not the portable device reception unit 22 has received a position detection signal transmitted from the on-board device 1 (step S12). Upon successfully demodulating a position detection signal that has been modulated, the on-board device 1 determines that the portable device reception unit 22 has successfully received a position detection signal. Upon determining that a position detection signal has been successfully received (step S12: YES), the portable device control unit 21 transmits a response signal to the on-board device 1 (step S13). Upon completing processing in step S13, or upon determining that a position detection signal has not been received (step S12: NO), the portable device control unit 21 detects the walk state of the user A, i.e. the vibration state of the portable device control unit 21, using the walk detection unit 25 (step S14). Then, the portable device control unit 21 transmits a walk state signal that indicates the walk state of the user A detected by the walk detection unit 25, using the portable device transmission unit 23 (step S15).

In an active state, the portable device 2 repeatedly performs processing in steps S12 to S15 regardless of whether or not a position detection signal has been received, and intermittently transmits at least walk state signals to the on-board device 1.

Upon transmitting a position detection signal in step S11, the on-board control unit 11 determines whether or not the on-board reception unit 12 has received a response signal that is transmitted from the portable device 2 in response to a position detection signal (step S16). Upon determining that a response signal has been received (step S16: YES), the on-board control unit 11 returns processing to step S11.

Upon determining that a response signal has not been received (step S16: NO), the on-board control unit 11 refers to information regarding the walk state indicated by a walk state signal to determine whether or not there are vibrations in the portable device 2 (step S17). That is, the on-board control unit 11 determines whether or not there are vertical vibrations in the portable device 2 due to the user A walking. Upon determining that there are no vibrations in the portable device 2 (step S17: NO), the on-board control unit 11 returns processing to step S11.

Upon determining that there are vibrations in the portable device 2 (step S17: YES), the on-board control unit 11 determines whether or not a state where a response signal has not been received and there are vibrations in the portable device 2 is continuing (step S18). For example, if the on-board control unit 11 determines that a response signal has not been received and there are vibrations in the portable device 2 in steps S16 and S17 a predetermined number of times or more in a row, the on-board control unit 11 determines that the above-described state is continuing. Alternatively, in a modification, the on-board control unit 11 may measure the time elapsed from when the above-described state was detected for the first time, using the timer unit 11a, and determine that the above-described state is continuing if the above-described state is held even after a predetermined period of time has elapsed.

Note that the on-board control unit 11 that performs steps S16 to S17 functions as a determination unit that determines whether or not the vehicle doors need to be locked, based on the walk state of the user A indicated by a walk state signal, and the reception state of a response signal.

Upon determining that the above-described state is not continuing (step S18: NO), the on-board control unit 11 returns processing to step S11. Upon determining that the above-described state is continuing (step S18: YES), the on-board control unit 11 outputs a lock signal to the door ECU 6, using the output unit 15 (step S19), and terminates processing. The vehicle doors are locked as a result of the lock signal being output.

The following specifically describes operations of the on-board device 1 and the portable device 2 that perform the above-described processing.

FIG. 5 is a conceptual diagram showing the communication range of position detection signals, and response signals and walk state signals, and FIG. 6 is a conceptual diagram showing the communication range of position detection signals, and walk state signals, in a situation where the user A moves away from the vehicle C. Upon the user A who has got out of the vehicle C closing the vehicle door, position detection signals are transmitted from the first to third LF transmission antennas 31, 32, and 33 of the on-board device 1. In FIGS. 5 and 6, the semicircles represented by two-dot chain lines indicate position detection signals transmitted from the first to third LF transmission antennas 31, 32, and 33, and the sizes thereof indicate ranges in which the portable device 2 can receive the position detection signals.

When the user A is located in the vicinity of the vehicle C, the portable device 2 can receive a position detection signal, and transmits a response signal and a walk state signal to the on-board device 1. In FIG. 5, the solid arrow represents the response signal, and the dashed arrow represents the walk state signal.

As shown in FIG. 6, if the portable device 2 is moved away from the vehicle C and leaves the ranges in which the portable device 2 can receive a position detection signal, the portable device 2 only transmits a walk state signal to the on-board device 1, without transmitting a response signal. Even if the user A leaves the ranges in which the portable device 2 can receive a position detection signal, there are cases where the user A has simply stopped near the vehicle C, at a position that is obliquely rearward of the vehicle C, for example, and is not away from the vehicle C. Therefore, in addition to determining whether or not a response signal has been received, the on-board device 1 monitors the walk state of the walker, using the walk state signal, and locks the vehicle doors when a response signal has not been received and continuous vibrations in the portable device 2, which are generated as a result of the user A walking, have been detected, as shown in FIG. 6. Even if a response signal has not been received, the on-board device 1 does not lock the vehicle doors when the portable device 2 is not vibrating. Also, if a response signal has not been received, and the vibrating state of the portable device 2 is a temporary state, the on-board device 1 does not lock the vehicle doors.

With the vehicle communication system with such a configuration, it is possible to detect, without error, a situation where the portable device 2 is moved away from the vehicle C, and to lock the vehicle doors.

In particular, according to the first embodiment, it is possible to detect, without error, a situation where the portable device 2 is moved away from the vehicle C, in view of vibrations in the portable device 2 generated as a result of the user A walking, in addition to the reception state of a response signal, and to lock the vehicle doors.

Furthermore, the on-board device 1 can more accurately detect a situation where the user A moves away from the vehicle C, and lock the vehicle doors.

### Second Embodiment

A vehicle communication system according to a second embodiment has the same configuration as the vehicle communication system according to the first embodiment, but is different in the configuration of a walk detection unit 225 and processing procedures that are performed by the on-board device 1 and a portable device 202. Since the other configurations and the actions and effects are the same as those in the first embodiment, the following mainly describes the differences. Components that correspond to each other are assigned the same reference numerals, and detailed descriptions thereof are omitted.

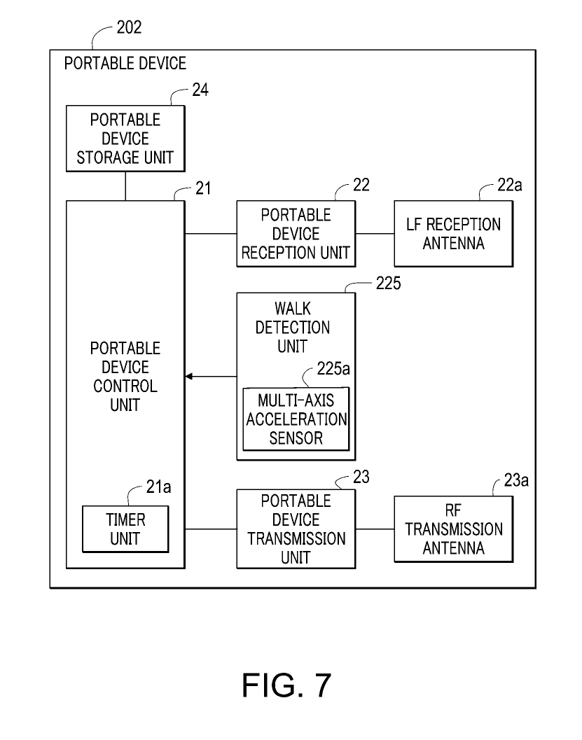

FIG. 7 is a block diagram showing an example of the configuration of the portable device 202 according to the second embodiment. The portable device 202 according to the second embodiment has the same configuration as in the first embodiment. The walk detection unit 225 according to the second embodiment includes a multi-axis acceleration sensor 225a, which is specifically a three-axis acceleration sensor. The walk detection unit 225 detects vibrations in the vertical direction and a linear acceleration in the forward direction, which are generated as a result of the user A holding the portable device 202 walking, and outputs a signal that indicates the vibrations in the vertical direction and the linear acceleration thus detected, to the portable device control unit 21.

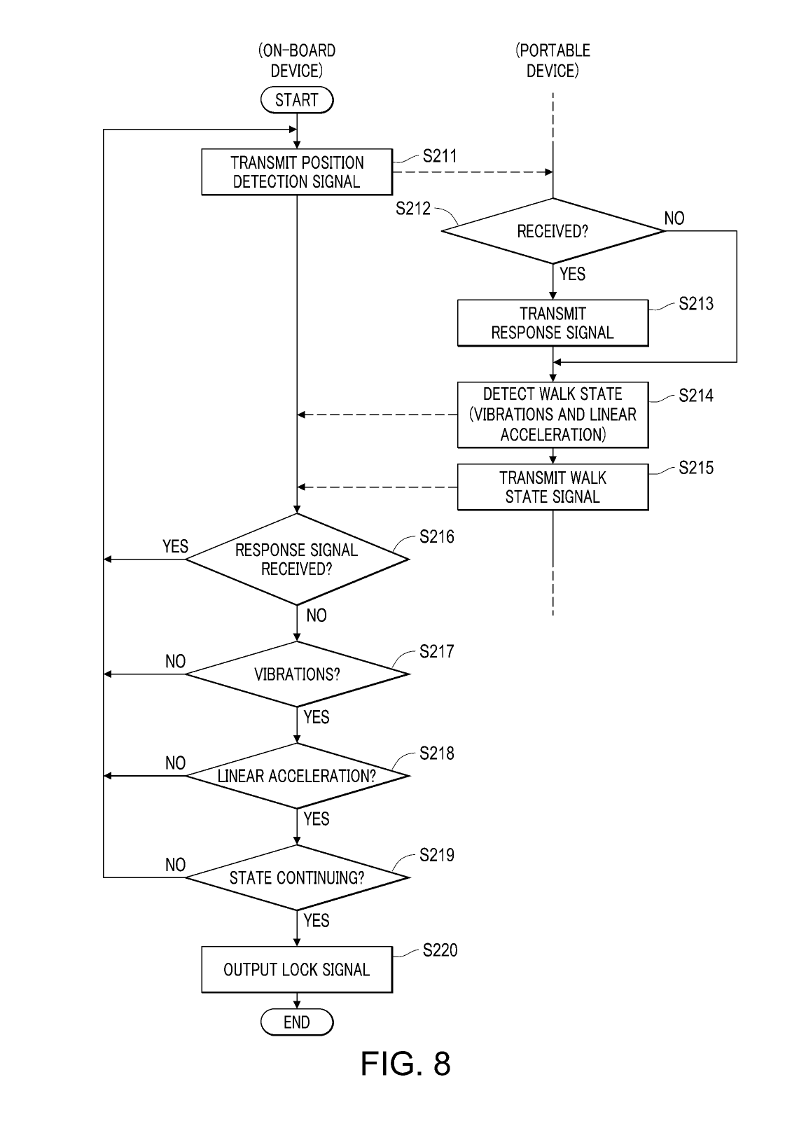

FIG. 8 is a flowchart showing processing procedures for locking according to the second embodiment. In steps S211 to S217, the on-board device 1 and the portable device 202 perform the same processing as in steps S11 to S17. However, a walk state detected by the portable device control unit 21 in step S214 is vibrations in the vertical direction and a linear acceleration generated as a result of the user A walking, and the walk state signal transmitted in step S215 indicates vibrations and a linear acceleration.

Upon determining that there are vibrations in the portable device 202 in step S217 (step S217: YES), the on-board control unit 11 refers to information regarding the walk state indicated by the walk state signal, to further determine whether or not the acceleration of the portable device 202 is linear (step S218). Here, “acceleration is linear” refers to a state where acceleration increases or decreases in a constant direction. Acceleration that increases or decreases in a constant direction and thereafter equals to zero as a result of the walker moving at a constant speed is also referred to as a linear acceleration.

Upon determining that the acceleration of the portable device 202 is not linear (step S218: NO), the on-board control unit 11 returns processing to step S211. Upon determining that the acceleration of the portable device 202 is linear (step S218: YES), the on-board control unit 11 determines whether or not a state where a response signal has not been received, there are vibrations in the portable device 202, and the acceleration is linear is continuing (step S219).

Upon determining that the above-described state is not continuing (step S219: NO), the on-board control unit 11 returns processing to step S211. Upon determining that the above-described state is continuing (step S219: YES), the on-board control unit 11 outputs a lock signal to the door ECU 6, using the output unit 15 (step S220), and terminates processing. The vehicle doors are locked as a result of the lock signal being output.

Note that the on-board control unit 11 that performs steps S216 to S219 functions as a determination unit that determines whether or not the vehicle doors need to be locked, based on the walk state of the user A indicated by a walk state signal, and the reception state of a response signal.

With a vehicle communication system with such a configuration, it is possible to detect, without error, a situation where the portable device 202 is moved away from the vehicle C, in view of vibrations and the acceleration of the portable device 202, which are generated as a result of the user A walking, in addition to the reception state of a response signal, and to lock the vehicle doors.

Although the portable devices 2 and 202 in the first and second embodiments are illustrated as dedicated devices, a communication device that has similar communication functions, such as a wearable terminal or a smartphone, may be employed as the portable device 2 or 202.

The embodiments disclosed herein are examples in all respects, and are not to be construed as limiting. The scope of the present invention is defined by the claims rather than by the meaning of the description above, and all modifications equivalent to and within the scope of the claims are intended to be encompassed.

### LIST OF REFERENCE NUMERALS

1: On-board Device
2, 202: Portable Device
3: LF Transmission Antenna
4: RF Reception Antenna
5: Door Switch
6: Door ECU
7: Open/Close Detection Switch
11: On-board Control Unit
11a: Timer Unit
12: On-board Reception Unit
13: On-board Transmission Unit
14: On-board Storage Unit
15: Output Unit
21: Portable Device Control Unit
21a: Timer Unit
22: Portable Device Reception Unit
22a: LF Reception Antenna
23: Portable Device Transmission Unit
23a: RF Transmission Antenna
24: Portable Device Storage Unit
25, 225: Walk Detection Unit
25a: Vibration Sensor
31: First LF Transmission Antenna
32: Second LF Transmission Antenna
33: Third LF Transmission Antenna
61: Lock/Unlock Mechanism
62: Actuator
225a: Multi-axis Acceleration Sensor
A: User
C: Vehicle

1. A vehicle communication system comprising:
an on-board device configured to transmit a position detection signal; and
a portable device configured to receive the position detection signal and transmit a response signal, the on-board device configured to output a lock signal that provides an instruction to lock a vehicle door depending on a reception state of the response signal transmitted from the portable device,
wherein the portable device is configured with memory and a processor configured to:
detect a walk state of a user holding the portable device; and
transmit a walk state signal that indicates the walk state of the user detected by the portable device, and
the on-board device is configured with memory and a processor configured to:
receive the response signal and the walk state signal transmitted from the portable device;
determine whether or not the vehicle door needs to be locked, based on the walk state of the user indicated by the walk state signal and the reception state of the response signal; and
output the lock signal upon determining that the vehicle door needs to be locked,
the portable device intermittently transmits the walk state signal even after the position detection signal is no longer received, and
the on-board device outputs the lock signal if it is determined, a plurality of times, that the vehicle door needs to be locked, based on the walk state signal intermittently transmitted from the portable device.

2. The vehicle communication system according to claim 1,
wherein the portable device includes a vibration sensor configured to detect vibrations generated as a result of the user walking, and
the on-board device determines that the vehicle door needs to be locked if the vibration sensor has detected continuous vibrations generated as a result of the user walking, and the response signal transmitted from the portable device that has received the position detection signal has not been received.

3. The vehicle communication system according to claim 1,
wherein the portable device includes a multi-axis acceleration sensor that detects vibrations and a linear acceleration generated as a result of the user walking, and
the on-board device determines that the vehicle door needs to be locked if the multi-axis acceleration sensor has detected continuous vibrations and a linear acceleration generated as a result of the user walking, and the response signal transmitted from the portable device that has received the position detection signal has not been received.

4. (canceled)

5. An on-board device that transmits a position detection signal, and provides an instruction to lock a vehicle door depending on a reception state of a response signal transmitted from a portable device that has received the position detection signal, the on-board device configured with memory and a processor configured to:
receive the response signal and a walk state signal transmitted from the portable device, the walk state signal indicating a walk state of a user holding the portable device;
determine whether or not the vehicle door needs to be locked, based on the walk state of the user indicated by the walk state signal, and the reception state of the response signal; and
output a lock signal upon determining that the vehicle door needs to be locked, the lock signal providing an instruction to lock the vehicle door,
wherein the portable device is configured to intermittently transmit the walk state signal even after the position detection signal is no longer received, and
the on-board device is configured to output the lock signal if the on-board device determines, a plurality of times, that the vehicle door needs to be locked, based on the walk state signal intermittently transmitted from the portable device.

6. A portable device that receives a position detection signal transmitted from an on-board device, and transmits a response signal, the portable device configured with memory and a processor configured to:
detect a walk state of a user holding the portable device; and
transmit a walk state signal that indicates the detected walk state of the user,
wherein the portable device intermittently transmits the walk state signal even after the position detection signal is no longer received.
